(19) United States
(12) Patent Application Publication
(10) Pub. No.: US 2001/0014861 A1
(43) Pub. Date: Aug. 16, 2001

(54) Voice internet service system

(76) Inventor: Ki-Ho Oh, Seoul (KR)

Correspondence Address: ROBERT E. BUSHNELL, 1522 K STREET NW, SUITE 300, WASHINGTON, DC, 200051202

(21) Appl. No.: 09/769,474

(22) Filed: Jan. 26, 2001

(30) Foreign Application Priority Data
Jan. 26, 2000 (KR) 3616/2000

(51) Int. Cl. G10L 11/00

(52) U.S. Cl. 704/270.1

(57) ABSTRACT

An Internet service system using voice includes a voice recognition means for recognizing a user's voice to an Internet service demand through voice of the user and an Internet server for processing an information in order to provide the user demanded service to the voice recognized user. The system further includes a voice synthesis means for providing the information processed by the Internet server to the user after converting the information into voice.

### CLAIM OF PRIORITY

This application makes reference to, incorporates the same herein, and claims all benefits accruing under 35 U.S.C. §119 from my application VOICE INTERNET SERVICE SYSTEM filed with the Korean Industrial Property Office on Jan. 26, 2000 and there duly assigned Serial No. 3616/2000.

### BACKGROUND OF THE INVENTION

1. Technical Field

The present invention relates to an Internet service providing system; and, more particularly, to a voice using Internet service providing system which processes informations to provide a user with an Internet service demanded by the user in voice and provides the information processed to the user in voice through a voice recognition and a voice synthesis.

2. Related Art

Recently, Internet service population rapidly increased according to the progress of key communication network and rapid propagation of personal computers, thus the Internet is becoming a necessary tool in human life.

Therefore, the generalization of Internet makes the Internet used not only in personal computers but also in other terminals, e.g., telephone. Further, persons who are not familiar with personal computers (PC) need easier Internet use.

However, as shown in FIG. 1, current Internet service providing system provides Internet service to the user through the user's input of uniform resource locator (URL) of a web site for visiting the web site, or searching word in text form for visiting the searched web site, after the user's Internet connection through a computer.

Therefore, there is a problem that the users who are not familiar with the computer as a word input means can't easily use the Internet service because the user is able to use the Internet service only through word inputting.

### SUMMARY OF THE INVENTION

It is, therefore, a primary object of the invention is to provide a processed information to a user in voice form after processing the information in order to provide an Internet service to the user through an Internet service demand inputted as voice information from the user through a voice recognition and a voice synthesis.

Another object of the invention is to provide a voice Internet portal service, thereby allowing the user to receive Internet portal service through voice.

Another object of the invention is to provide a voice Internet portal service providing ordered service to each single user. Another object of the invention is to provide an Internet searching service to the user. Another object of the invention is to provide an Internet direct connecting service to the user. Another object of the invention is to provide a specific telephone service to the user.

According to the present invention, an Internet service providing system using voice comprises: a voice recognition means for recognizing the voice of a user per the Internet service demanded by the user in voice, an Internet server for processing information to provide the voice recognized user with the demanded services and a voice synthesizing means for providing the information processed by the Internet server to the user after converting the processed information into voice.

The voice recognition means comprises an apparatus for identifying a dual tone multifrequency (DTMF) tone generated through a user's phone. The Internet service demand is performed according to a menu designation method through voice or searching word inputting method.

Preferably, the Internet server transfers a preset personal ordered service menu to the user who demanded service after converting the preset service into voice through the voice synthesis means. Further, the Internet server connects with the site which the voice recognized user demanded, then provides data received from the demanded site to the user after converting the data into voice through the voice synthesis means.

According to the present invention, if the user demanded service is an electronic mail confirmation, the Internet server provides a received mail to the user after converting the mail into voice through the voice synthesis means. Further, if the user demanded service is an electronic mail transfer, the Internet server receives a mail address of a mail receiver by a certain method and transfers a mail inputted by voice to the mail receiver after converting the mail into text through the voice recognition means. At this time, the user can input the mail address of the mail receiver in voice through searching a user mail address book database existing in the Internet server.

Furthermore, if the user demanded service is a schedule management, the Internet server provides a preset schedule information for the user to the user after converting the information into voice through the voice synthesis means. If the user demanded service is a weather of the date, the Internet server on the basis of a preset user's address information provides a weather information proper to the area where the user lives to the voice synthesis means and provides the weather information to the user after converting the information into voice through the voice synthesis means. If the user demanded service is a horoscope or fortune, the Internet server on the basis of a preset user's birthday date information provides the horoscope or fortune information of the user to the user after converting the information into voice through the voice synthesis means. If the user demanded service is a news, the Internet server provides a news information received from one or more newspaper companies to the user after converting the news information into voice through the voice synthesis means.

Further, preferably, the Internet server searches a voice searching word from the user inputted in text form through the voice recognition means and provides a searched result to the user after converting the result into voice through voice synthesis means.

Further, the Internet server has database of titles and characteristic number codes of respective registered home pages. If the Internet direct connecting service is demanded by the user, the Internet server connects with the service demanded home page after the input of the title and characteristic number code of the demanded home page and provides the contents of the home page to the user after converting the contents into voice through the voice synthesis means.

Further, the Internet server stores specific telephone services after registering the services, then provides the telephone service informations to the user according to the demand of the user after converting the information into voices through the voice synthesis means. If the service demanded by the user is a specific telephone service direct connecting, the Internet server directly connects with the specific telephone service.

Further, if the user demanded service is the specific telephone service, the Internet server provides a searching result to the voice synthesis means after searching the specific telephone service, then provides the result to the user after converting the result into voice.

To achieve these and other objects in accordance with the principles of the present invention, as embodied and broadly described, the present invention provides a voice Internet service system, comprising: a voice recognition unit recognizing a user's voice in response to a voice Internet service demand by the user; an Internet server processing information in order to provide the service demanded by the voice recognized user; and a voice synthesis unit converting the information processed by said Internet server into voice information to provide the user with the voice information.

To achieve these and other objects in accordance with the principles of the present invention, as embodied and broadly described, the present invention provides a voice apparatus, comprising: a voice recognition unit recognizing a user's voice when a voice service demand is received from the user; a server accessing information to provide the service demanded by the voice recognized user; and a voice synthesis unit converting the information accessed by said server into voice information and conveying the voice information to the user.

To achieve these and other objects in accordance with the principles of the present invention, as embodied and broadly described, the present invention provides an Internet method, comprising: recognizing a user's voice in response to a voice Internet service demand by the user; processing information in order to provide the service demanded by the voice recognized user; converting the information processed into voice information; and providing the user with the voice information.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 illustrates an Internet service;

FIG. 2 shows a servicing idea based on the Internet service providing system through voice, in accordance with the principles of the present invention;

FIG. 3 depicts service types of the Internet service providing system, in accordance with the principles of the present invention, and a driving idea for the system;

FIG. 4 describes a personal ordered service executing process of the Internet service providing system, in accordance with the principles of the present invention;

FIG. 5 presents an electronic mail confirmation service executing process in the personal ordered service of the Internet service providing system, in accordance with the principles of the present invention;

FIG. 6 depicts an electronic mail transfer service executing process in the personal ordered service of the Internet service providing system, in accordance with the principles of the present invention;

FIG. 7 describes an address book service executing process in the personal ordered service of the Internet service providing system, in accordance with the principles of the present invention;

FIG. 8 represents a weather of the date service executing process in the personal ordered service of the Internet service providing system, in accordance with the principles of the present invention;

FIG. 9 shows a voice Internet search executing process of the Internet service providing system, in accordance with the principles of the present invention; and

FIG. 10 depicts an Internet direct connecting executing process of the Internet service providing system, in accordance with the principles of the present invention.

### DETAILED DESCRIPTION OF THE PREFERRED EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Following terms are defined by considering the function thereof in the present invention. The terms are capable of varying according to an intention of a those skilled in the art or a usual practice. Therefore, the definitions of the terms must be determined through all contents of the specification of the present invention.

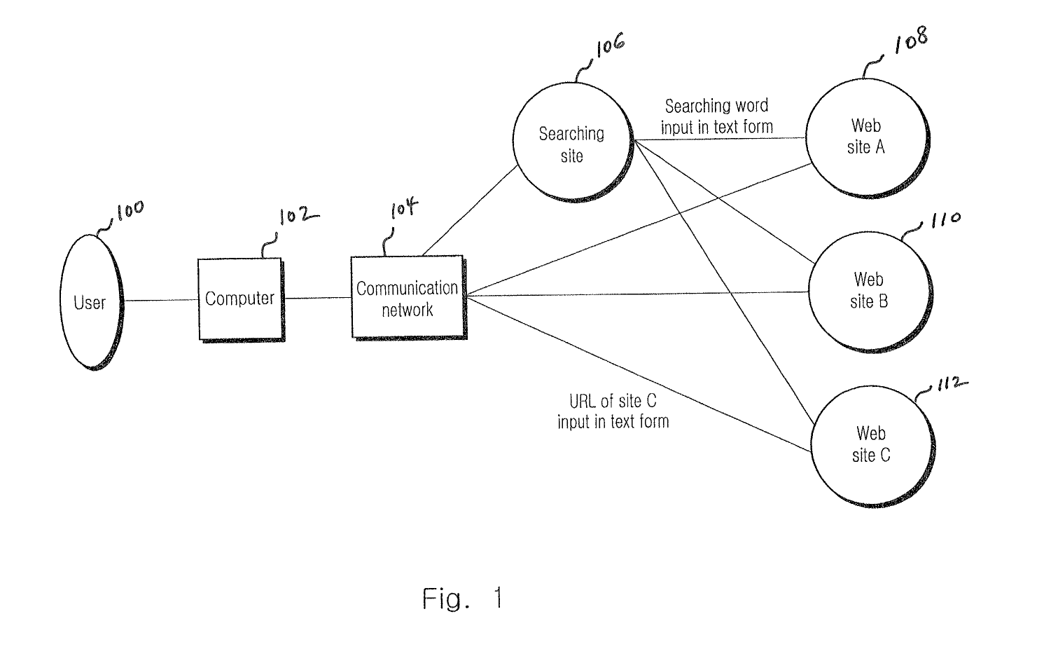

FIG. 1 shows an Internet service with user 100, computer 102, communication network 104, searching site 106, web site A 108, web site B 110, and web site C 112.

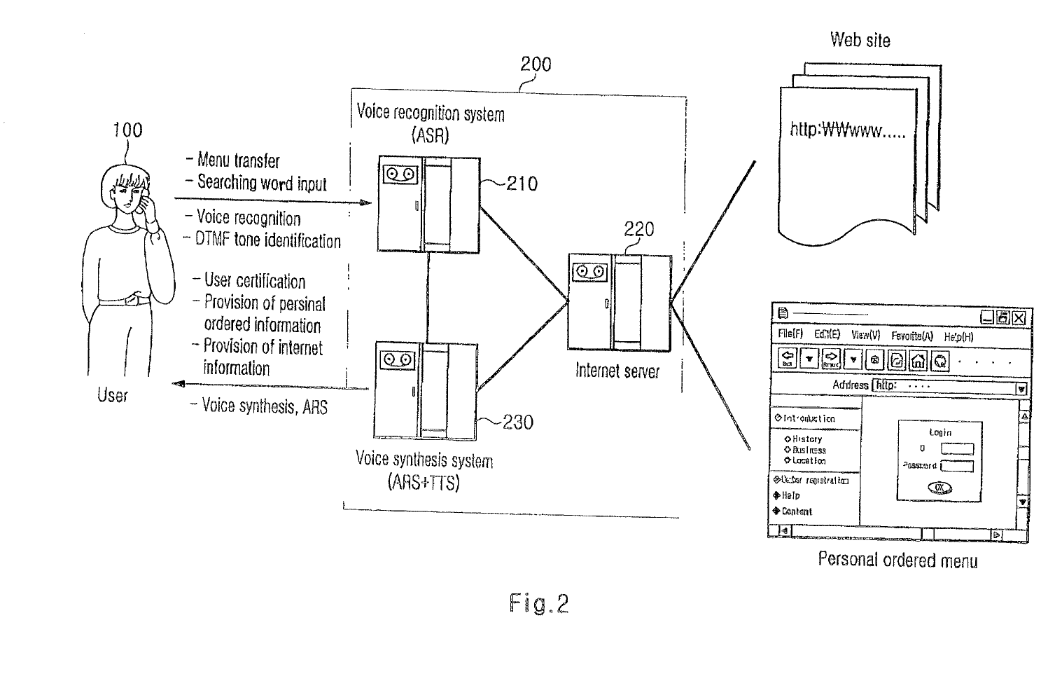

An Internet service providing system through voice according to the present invention is now described with reference to FIG. 2. When a user 100 connects with the Internet service providing system 200 and generates a voice or a dual tone multifrequency (DTMF) tone, for example, to demand Internet service through menu designation, searching word input, etc., a voice recognition system 210 recognizes the voice and the DTMF tone for the Internet service demand of the user. Then the Internet server 220 executes a service to the voice recognized user's demand. A voice synthesis system 230 transfers a processed service, e.g., a user certification, provision of personal ordered information, provision of Internet information and the like., by the Internet server 220 to the user 100 after converting the service into voice.

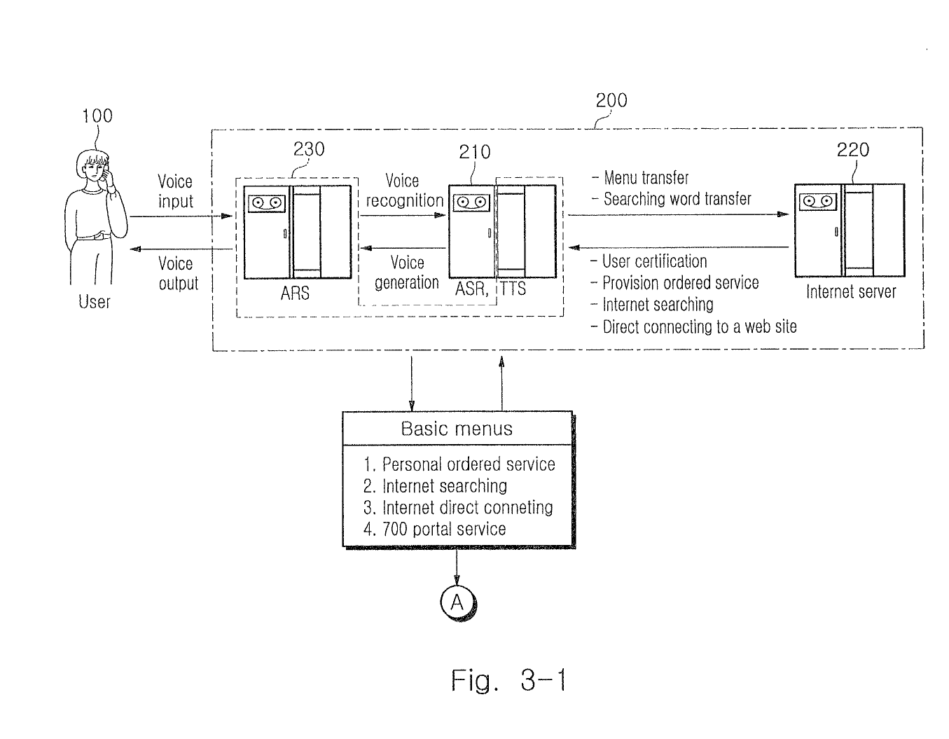

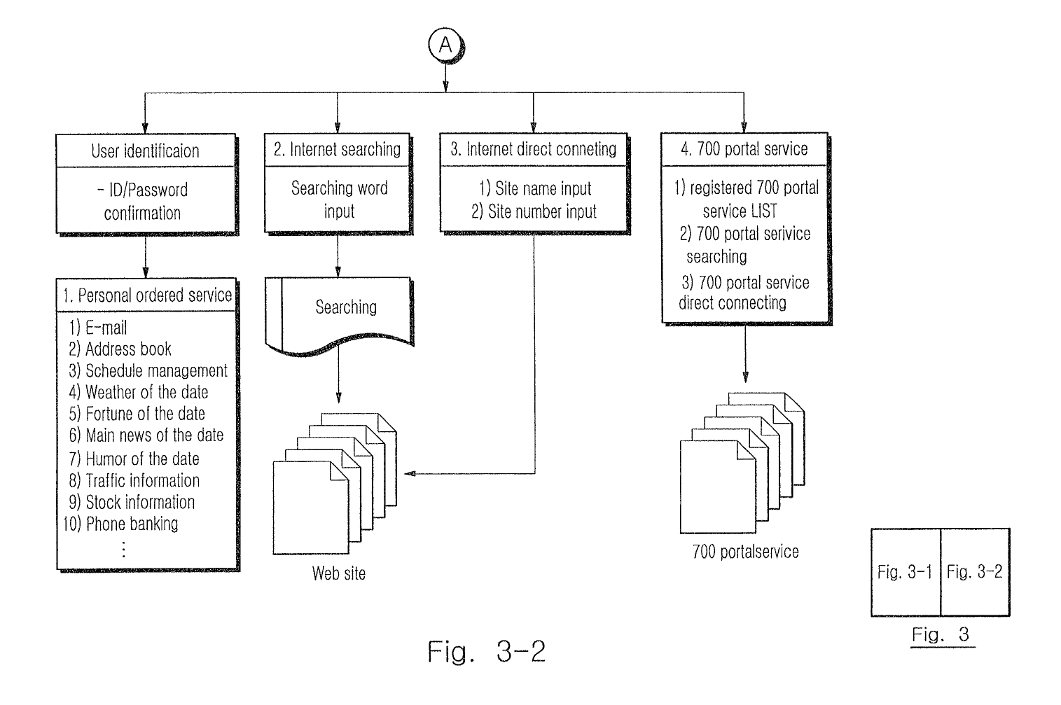

Referring to the FIG. 3, service types and a driving idea of the Internet service providing system of the present invention will now be described.

When the user 100 connects with the Internet service providing system 200 through telephone, the system 200 generates guide massage through the voice synthesis system 230, e.g., Audio Response System (ARS). Then, when a voice is inputted by the user 100, the system 200 transfers an information such as the menu or a searching word which the user designated to the Internet server 220 through a voice recognition system 210, e.g., Automatic Send Receive set (ASR).

The Internet server 220 provides a personal ordered service, an Internet searching service, an Internet direct connecting service and a specific telephone service as basic menus. Further, the Internet server 220 outputs the provided menus to the user for voice answer after converting the menus into voice through the voice synthesis system 230, e.g., Text-to-Speech conversion (TTS) and ARS.

Each of the services are as follows.

1) personal ordered service

Generally, the voice Internet service has a limit of using time. Therefore, a minimum time must be used in an effective acquiring of an information which the user demands and thus the personal ordered service is required.

The personal ordered service can be divided into a user ordered service wherein the user can designate a service he wants therein and a server ordered service wherein the Internet server on the basis of a user profile automatically sets an information therein proper to the user.

Therefore, the user can designate a service he wants in a plurality of services provided from a portal site. Further, the designated service is constituted in ordered form according to the profile of the user.

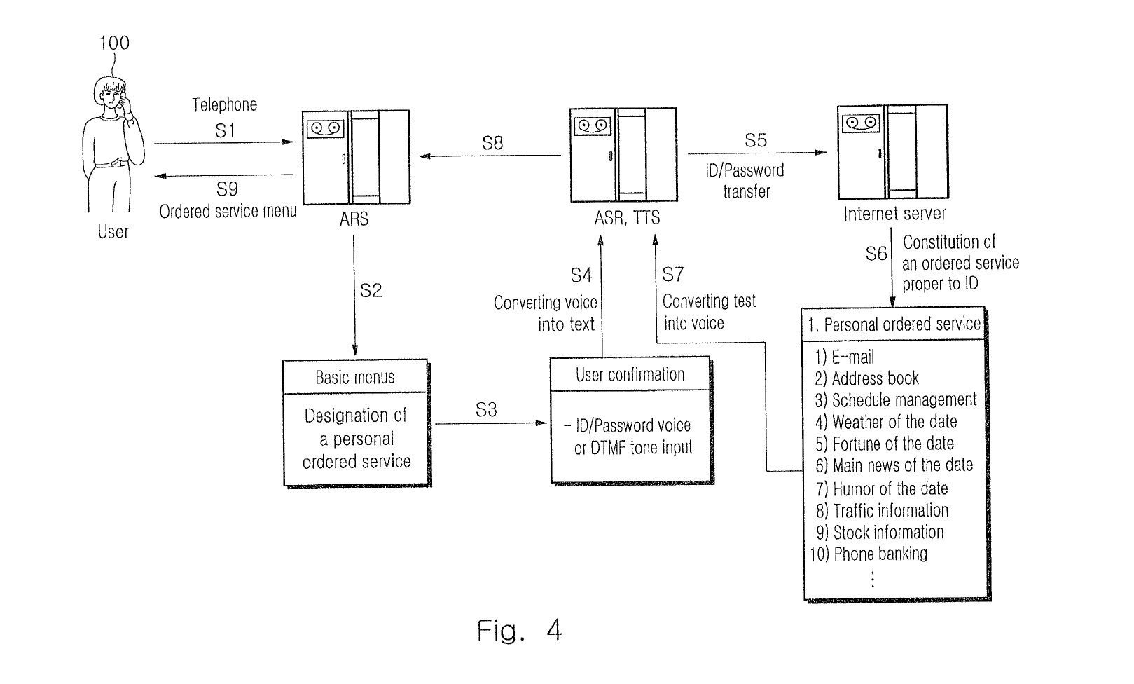

Referring to FIG. 4, these are as follows.

When, the user 100 telephones to the Internet service providing system 200 (S1), the ARS generates guide message about basic menus (S2). Then, if the user designates a personal ordered service in the basic menus, a user confirmation work is executed for executing the personal ordered service (S3). That is, the system 200 receives identification number (ID)/password information in voice or DTMF tone from the user.

Then, the inputted voice is converted into text through the ASR (S4). The ID/Password in text form is transferred to the Internet server (S5).

The Internet server constitutes an ordered service proper to the inputted ID (S6), and then transfers the ordered service to TTS to convert the personal ordered service lists into voice through (S7).

The voices corresponding to the converted personal ordered service lists are transferred to the ARS (S8). Then, the ARS informs the user (S9) of the ordered service menus.

The personal ordered services include an electronic mail, an address book, a schedule management, a weather of the date, a fortune of the date, a main news of the date, a humor of the date, a traffic information, a stock information, a phone banking and so on, and other services can be added thereto.

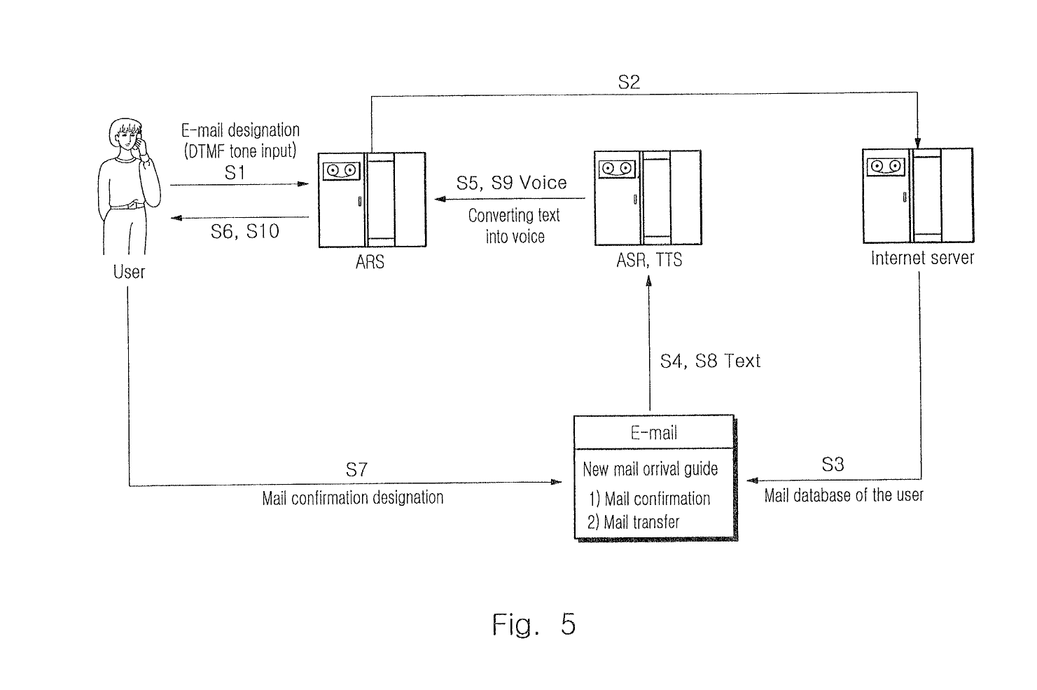

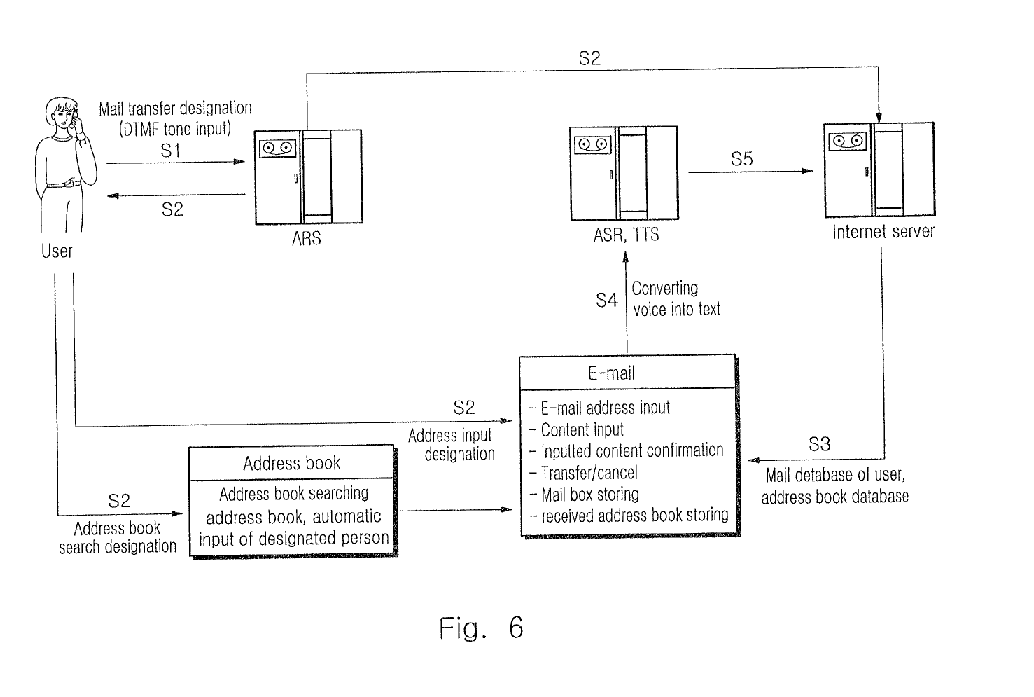

Electronic mail service of the personal ordered services executes a mail confirmation and a mail transfer as shown in FIGS. 5 and 6.

The mail confirmation process will now be described with reference to FIG. 5. If the user designates the electronic mail service, i.e., a DTMF tone is generated through the user's input of the telephone key corresponding to the electronic mail, in the personal ordered services (S1). If the ARS perceives the designation (S2), the Internet server reads the user's mail database (S3), then converts the database into voice through TTS (S4), transfers the voice to the ARS (S5), and informs the user of the arrival of a new mail (S6).

For example, the ARS generates the guidance message “Now, three new mails are exist. Please press number 1 if you want to confirm the mail or number 2 if you want to send the mail.”.

If the user designates to confirm the mails (S7) after informed of the mail arrival through ARS, the Internet server converts contents of the new mails into voice through TTS (S8), transfers the voice to the ARS (S9), and allows the user to hear the contents of the new mails (S10).

For example, “Received time of the first mail is 8 o'clock 25 minutes p.m., November 25th. The Sender of the mail is Cho, Jang-gwan. The content of the mail is as follows . . . If you want to reply, please press number 1, or if you want to continue to hear the mail, please press number 2.”.

The mail transfer process will now be described with reference to FIG. 6. The user designate the mail transfer, or, when a DTMF tone is generated through the user's telephone key input corresponding to the mail transfer, in the electronic mail services (S1). If the ARS perceives the designation, the ARS informs the user to input an address information of a receiver (S2).

For example, the ARS generates the guidance message “Please press number 1 if you want to input the electronic mail address of a receiver or press number 2 if you want to search an address book.”.

At this time, if the user designates an address input (S2) and transfers the address information and the contents of mail in voice, the ARS converts the voice into text (S4), then transfers the mail of text through Internet server (S5).

On the other hand, if the user designates an address book search (S2), the Internet server reads a database of address book and a mail database of the user (S3) and converts them into voice through TTS (S4). Then, the Internet server provides the user with the persons stored in the address book database after transferring the voice to ARS. If the user designates a person and transfers a content to transfer in voice, the ARS converts the voice into text (S4), and then transfers the mail to the receiver through the Internet server (S5).

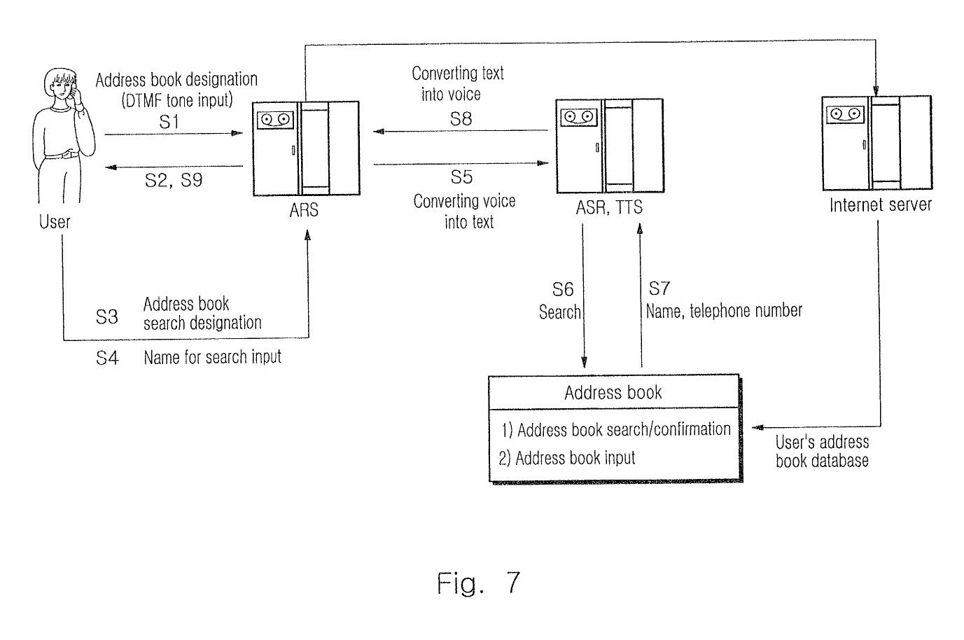

An address book management service will now be described in more detail with reference to FIG. 7 is as follows.

When the user selects the address book management service (S1), the ARS generates the guidance message “Please press number 1 if you want address book search or press number 2 if you want address book input.” (S2).

If the user designates an address book search (S3) and inputs a name for searching in voice (S4), the ARS converts the voice into text, and then searches the inputted name from the user's address book database transferred from the Internet server (S6).

After searching the name, the searched name and an address or a telephone number of the searched name are converted into voice through TTS, and then the voice is generated to the user through ARS (S8, S9).

For example, the ARS generates the guidance message “The office telephone number of Min, Hak-sang is 417-6456 and the hand phone number is 011-111-111.”.

Through above mentioned method, if the service demand of the user is the schedule management, the Internet server transfers a preset schedule information for the user to the user after converting the information into voice through the voice synthesis system comprising TTS and ARS.

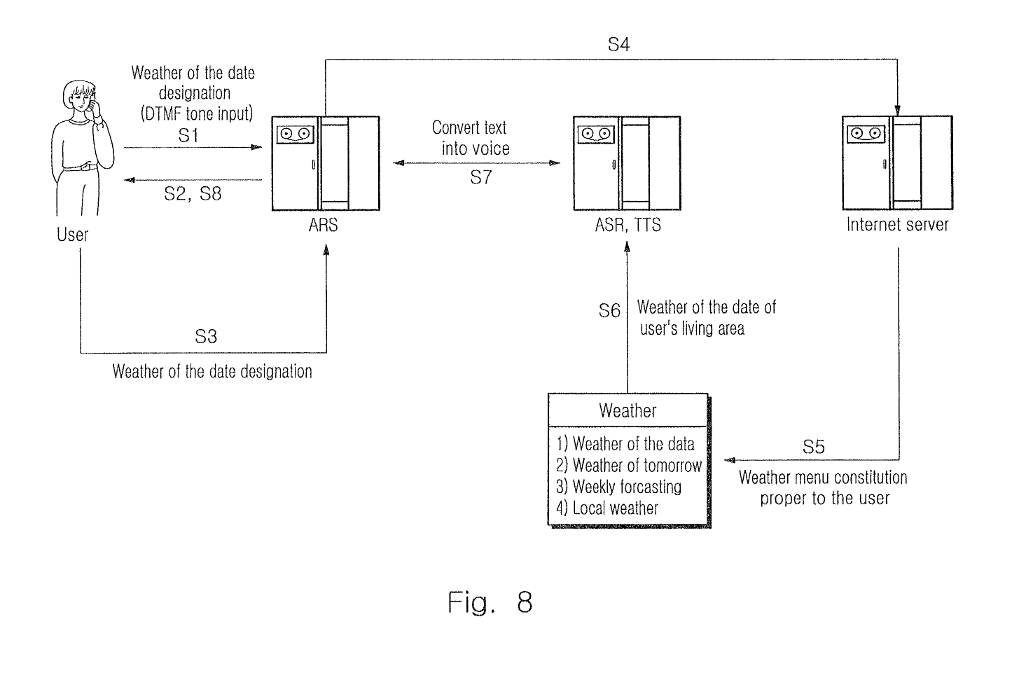

As shown if FIG. 8, if the user demanded service is the weather of the date, the Internet server on the basis of a preset user's address information transfers the weather information for an area where the user lives after converting the information into voice through the voice synthesis system comprising TTS and ARS.

Further, if the user demanded service is the fortune, the Internet server on the basis of a preset user's birthday date information transfers the fortune information to the user after converting the information into voice through the voice synthesis system comprising TTS and ARS.

If the user demanded service is the news, the Internet server transfers news information received from each of newspaper companies to the user after converting the news information into voice through the voice synthesis system comprising TTS and ARS.

2) voice Internet searching service

The Internet service providing system according to the present invention connects a voice recognition/generation system with the Internet searching system, searches an Internet site by an input of searching word which the user demanded, and transfers a searched result to the user in voice.

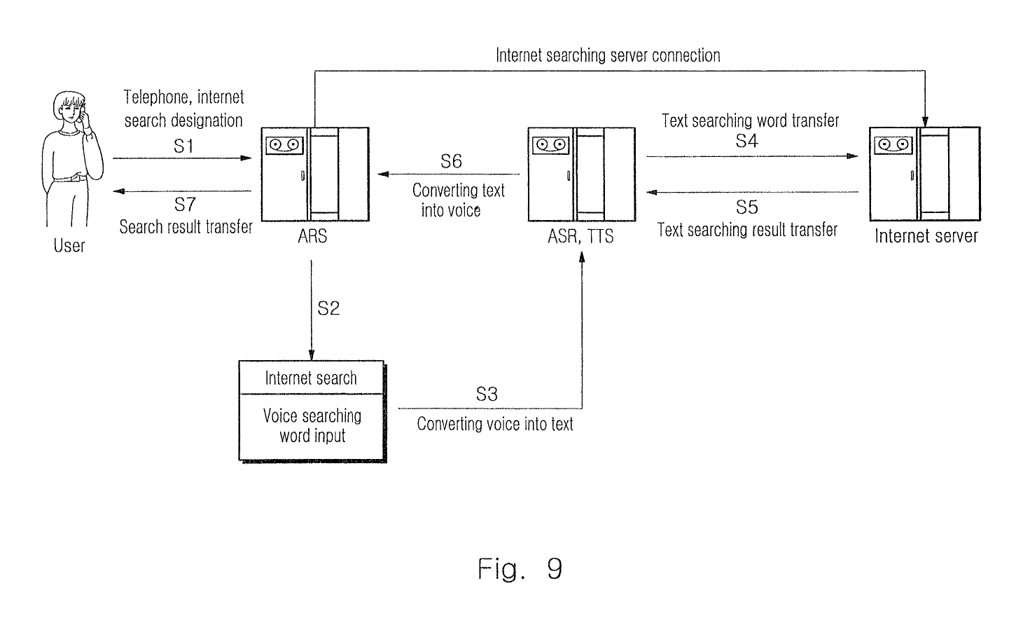

Referring to FIG. 9, if the user designate the Internet searching menu, i.e., a DTMF tone is generated through the user's telephone key input corresponding to the Internet searching menu (S1) and the ARS perceives the designation, the ARS informs the user of the designated menu and the input of searching word corresponding to contents for searching. After this the voice searching word is inputted (S2), the ASR converts the inputted voice searching word into text (S3), and then transfers the text searching word to the Internet server (S4).

The Internet server executes searching to the text searching word, and then transfers the text searching result to TTS (S5). The TTS transfers the text searching result to ARS after converting the result into voice (S6).

Then, the ARS informs the user of the searching result together with guide informations in voice (S7).

3) Internet direct connecting service

The Internet service providing system according to the present invention can provide the Internet direct connecting service by giving a title and a characteristic number code to a home page registered to a voice Internet portal service.

Further, the Internet server constitutes titles and characteristic number codes of respective registered home pages. If the Internet direct connecting service is demanded by the user, the Internet server connects with the service demanded home page after the input of the title and characteristic number code of the demanded home page and provides the contents of the home page to the user after converting the contents into voice through the voice synthesis system.

Preferably, the constitutions of the information to be provided in voice and the menu of the home page registered to the voice portal site are designed suitable to the ARS and TTS systems.

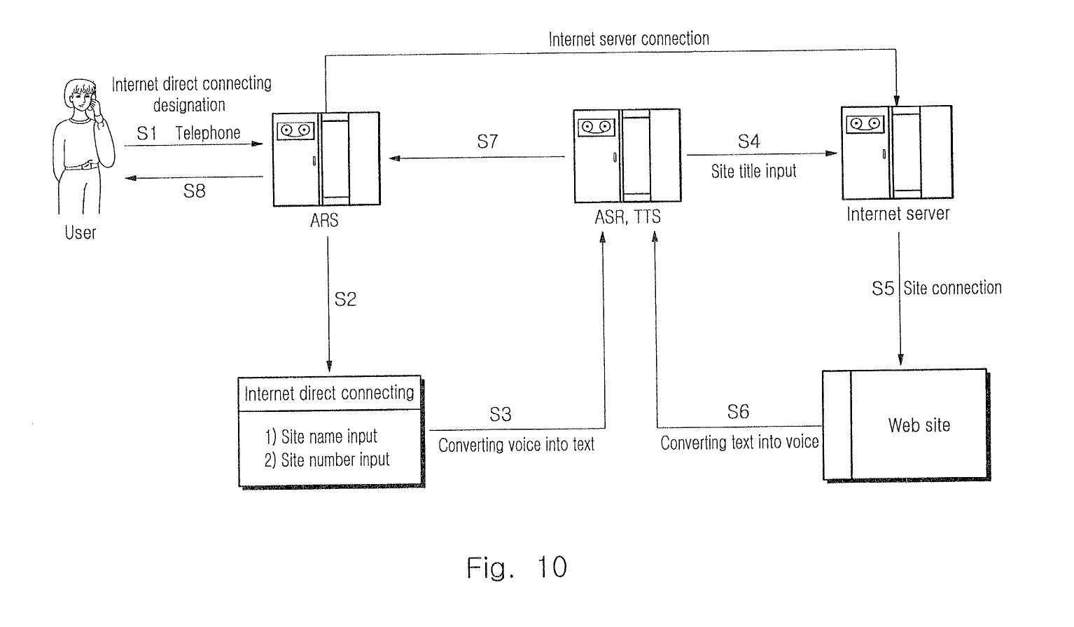

Referring to FIG. 10, if the user designates the Internet direct connecting menu (S1) (i.e., a DTMF tone is generated through the user's telephone key input corresponding to the Internet direct connecting menu) and the ARS perceives the designation, the ARS informs the user that the Internet direct connecting was designated and that the information of the site to be directly connected should be inputted, e.g., the ARS informs the user to input the name or title of the site or the characteristic code of the site. After the name of the site or the characteristic code of the site is inputted (S2), the ASR converts the inputted name of the site or the characteristic code of the site into text (S3), and then transfers the text to the Internet server (S4).

The Internet server connects with a corresponding site through the transferred site direct connecting information (S5), and then transfers the contents of the web site to TTS (S6). The TTS transfers the text searching result to ARS after converting the result into voice (S7).

Then, the ARS informs the user of the contents of the web site connected by direct connecting together with guide informations in voice (S8).

4) specific telephone service

The Internet service providing system according to the present invention can provide a unified specific telephone service in conjunction with the voice Internet portal site as follows.

The specific telephone service provided by the Internet service providing system according to the present invention provides the user with voice list classified in categories according to themes to the user, searches additional telephone service which the user wants, and performs a specific telephone direct connecting service which the user wants through the input of the title or the characteristic number.

That is, the Internet server stores specific telephone services after registering the services, and, as in the above mentioned process, transfers telephone services information to the user according to the demand of the user after converting the information into voice through the voice synthesis system.

Further, if the service demanded by the user is a specific telephone service direct connecting, the Internet server directly connects with the specific telephone service.

Finally, if the user demanded service is the specific telephone service, the Internet server provides searching result to the voice synthesis system after searching the specific telephone service, and provides the result to the user after converting the result into voice.

Therefore, the Internet service providing system according to the present invention can constitute a voice Internet portal site performing the voice service per the voice demand of the user.

As mentioned above, according to the present invention, the user is able to use the Internet with ease through voice communication means such as a telephone because the voice Internet service demand inputted by the user is processed through the voice recognition and the voice synthesis and the processed result is provided to the user in voice.

Although the invention has been shown and described with respect to the preferred embodiment according to the present invention, it will be understood by those skilled in the art that various changes and modifications may be made without departing from the spirit and scope of the invention as defined in the following claims. Therefore, other embodiments changed from the present embodiments could not depart from the scope of the present invention.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. A voice Internet service system, comprising:
a voice recognition unit recognizing a user's voice in response to a voice Internet service demand by the user;
an Internet server processing information in order to provide the service demanded by the voice recognized user; and
a voice synthesis unit converting the information processed by said Internet server into voice information to provide the user with the voice information.

2. The system of claim 1, said voice recognition unit comprising a unit identifying a dual tone multifrequency tone generated through a phone of the user.

3. The system of claim 1, the Internet service demand being performed according to one method selected from among a voice menu designation method and a voice searching word input method.

4. The system of claim 1, said Internet server transferring a preset personal ordered service menu to the user after converting the menu into voice through said voice synthesis unit.

5. The system of claim 1, said Internet server connecting with a site which the voice recognized user demands, and providing data received from the demanded site to the user after converting the data into voice through said voice synthesis unit.

6. The system of claim 1, said Internet server providing a received mail to the user after converting the mail into voice through said voice synthesis unit, when the user demanded service is an electronic mail confirmation.

7. The system of claim 1, said Internet server receiving a mail address of a mail receiver by a prescribed method and transferring a voice mail inputted to the mail receiver after converting the mail into text through said voice recognition unit, when the user demanded service is an electronic mail transfer.

8. The system of claim 7, the user inputting the mail address of the mail receiver in voice through searching a user mail address book database existing in said Internet server.

9. The system of claim 1, said Internet server providing the user a preset schedule information for the user after converting the information into voice through said voice synthesis unit, when the user demanded service is a schedule management.

10. The system of claim 1, when the user demanded service is weather information, said Internet server providing the weather information for an area where the user lives to said voice synthesis unit and providing the weather information to the user after converting the information into voice through said voice synthesis unit, said providing of the weather information being performed in dependence upon a preset user's address information.

11. The system of claim 1, when the user demanded service is weather information, said Internet server providing the weather information for a first geographical region to said voice synthesis unit and providing the weather information to the user after converting the information into voice through said voice synthesis unit, said providing of the weather information being performed in dependence upon said first geographical region.

12. The system of claim 1, when the user demanded service is a fortune, said Internet server providing the fortune information to the user after converting the information into voice through said voice synthesis unit, said providing of the fortune information being performed in dependence upon a preset user's date of birth information.

13. The system of claim 1, said Internet server providing news information received from at least one newspaper company to the user after converting the news information into voice through said voice synthesis unit, when the user demanded service is news information.

14. The system of claim 1, said Internet server searching a voice searching word of the user inputted in text form through said voice recognition unit and providing a searched result to the user after converting the result into voice through said voice synthesis unit.

15. The system of claim 1, said Internet server having a database of titles and characteristic number codes of respective registered home pages, said Internet server connecting with the service demanded home page after the input of the title and characteristic number code of the demanded home page and providing the contents of the home page to the user after converting the contents into voice through said voice synthesis unit when an Internet direct connecting service is demanded by the user.

16. The system of claim 1, said Internet server storing specific telephone services after registering the services, and providing the telephone services information to the user according to the demand of the user after converting the information into voice through said voice synthesis unit.

17. The system of claim 16, said Internet server directly connecting with the specific telephone service when the service demanded by the user is specific telephone service direct connecting.

18. The system of claim 16, said Internet server providing a searching result to said voice synthesis unit after searching the specific telephone service and providing the result to the user after converting the result into voice, when the user demanded service is a specific telephone service.

19. A voice apparatus, comprising:
a voice recognition unit recognizing a user's voice when a voice service demand is received from the user;
a server accessing information to provide the service demanded by the voice recognized user; and
a voice synthesis unit converting the information accessed by said server into voice information and conveying the voice information to the user.

20. The apparatus of claim 19, the user inputting the demand through Internet connections.

21. The apparatus of claim 20, the user inputting the demand by speaking into a microphone of a computer connected to Internet.

22. The apparatus of claim 20, the user inputting the demand by speaking into a telephone connected to Internet.

23. The apparatus of claim 20, the user inputting the demand by speaking into a personal digital assistant connected to Internet.

24. The apparatus of claim 20, said voice recognition unit comprising a unit identifying a dual tone multifrequency tone generated through a phone of the user.

25. The apparatus of claim 19, the service demand being performed according to one method selected from among a voice menu designation method and a voice searching word input method.

26. The apparatus of claim 19, said server transferring a preset personal ordered service menu to the user after converting the menu into voice through said voice synthesis unit.

27. The apparatus of claim 19, said server connecting with a site which the voice recognized user demands, and providing data received from the demanded site to the user after converting the data into voice through said voice synthesis unit.

28. The apparatus of claim 19, said server providing a received mail to the user after converting the mail into voice through said voice synthesis unit, when the user demanded service is an electronic mail confirmation.

29. The apparatus of claim 19, said server receiving a mail address of a mail receiver by a prescribed method and transferring a voice mail inputted to the mail receiver after converting the mail into text through said voice recognition unit, when the user demanded service is an electronic mail transfer.

30. The apparatus of claim 29, the user inputting the mail address of the mail receiver in voice through searching a user mail address book database existing in said Internet server.

31. The apparatus of claim 19, said server providing the user a preset schedule information for the user after converting the information into voice through said voice synthesis unit, when the user demanded service is a schedule management.

32. The apparatus of claim 19, when the user demanded service is weather information, said server providing the weather information for an area where the user lives to said voice synthesis unit and providing the weather information to the user after converting the information into voice through said voice synthesis unit, said providing of the weather information being performed in dependence upon a preset user's address information.

33. The apparatus of claim 19, when the user demanded service is weather information, said server providing the weather information for a first geographical region to said voice synthesis unit and providing the weather information to the user after converting the information into voice through said voice synthesis unit, said providing of the weather information being performed in dependence upon said first geographical region.

34. The apparatus of claim 19, when the user demanded service is one selected from among a horoscope and a fortune, said server providing the demanded information to the user after converting the information into voice through said voice synthesis unit, said providing of the horoscope and fortune information being performed in dependence upon a preset user's date of birth information.

35. The apparatus system of claim 19, said server providing news information received from at least one newspaper company to the user after converting the news information into voice through said voice synthesis unit, when the user demanded service is news information.

36. The apparatus of claim 19, said server searching a voice searching word of the user inputted in text form through said voice recognition unit and providing a searched result to the user after converting the result into voice through said voice synthesis unit.

37. The apparatus of claim 19, said server having a database of titles and characteristic number codes of respective registered home pages, said server connecting with the service demanded home page after the input of the title and characteristic number code of the demanded home page and providing the contents of the home page to the user after converting the contents into voice through said voice synthesis unit when a direct connecting service is demanded by the user.

38. The apparatus of claim 19, said server storing specific telephone services after registering the services, and providing the telephone services information to the user according to the demand of the user after converting the information into voice through said voice synthesis unit.

39. The apparatus of claim 38, said server directly connecting with the specific telephone service when the service demand ed by the user is specific telephone service direct connecting.

40. The apparatus of claim 38, said server providing a searching result to said voice synthesis unit after searching the specific telephone service and providing the result to the user after converting the result into voice, when the user demanded service is a specific telephone service.

41. An Internet method, comprising:
recognizing a user's voice in response to a voice Internet service demand by the user;
processing information in order to provide the service demanded by the voice recognized user;
converting the information processed into voice information; and
providing the user with the voice information.

42. The method of claim 41, said recognizing being performed by a voice recognition unit, said processing being performed by an Internet server, said converting being performed by a voice synthesis unit.

43. The method of claim 42, said voice recognition unit comprising a unit identifying a dual tone multifrequency tone generated through a phone of the user.

44. The method of claim 41, the Internet service demand being performed according to one method selected from among a voice menu designation method and a voice searching word input method.

45. The method of claim 42, further comprising transferring a preset personal ordered service menu to the user after converting the menu into voice through said voice synthesis unit.

46. The method of claim 41, connecting with a site which the voice recognized user demands, and providing data received from the demanded site to the user after converting the data into voice through said voice synthesis unit.

47. The method of claim 41, providing a received mail to the user after converting the mail into voice, when the user demanded service is an electronic mail confirmation.

48. The method of claim 41, receiving a mail address of a mail receiver by a prescribed method and transferring a voice mail inputted to the mail receiver after converting the mail into text, when the user demanded service is an electronic mail transfer.

49. The method of claim 48, the user inputting the mail address of the mail receiver in voice through searching a user mail address book database.
